(19) United States
(12) Patent Application Publication
(10) Pub. No.: US 2018/0079393 A1
(43) Pub. Date: Mar. 22, 2018

(54) TRUCK ICE AND SNOW MELTING SYSTEM

(71) Applicants: William R. Reid, Riverhead, NY (US); Robert C. Lehning, Rocky Point, NY (US)

(72) Inventors: William R. Reid, Riverhead, NY (US); Robert C. Lehning, Rocky Point, NY (US)

(21) Appl. No.: 15/709,204

(22) Filed: Sep. 19, 2017

Related U.S. Application Data
(60) Provisional application No. 62/396,500, filed on Sep. 19, 2016.

(51) Int. Cl. B60S 1/66; B60R 16/03

(52) U.S. Cl. CPC B60S 1/66; H05B 2214/02; B60R 16/03

(57) ABSTRACT

An ice and snow melting system for a surface of a transitory vehicle subject to receiving accumulations of snow or ice or combinations thereof when the transitory vehicle is stationary or in motion, includes one or more heating modules configured to be disposed on or beneath the surface to transfer heat to the accumulations of snow or ice or combinations thereof when the transitory vehicle is stationary or in motion, and a power source in communication with the one or more heating modules to effect transfer of heat from the heating modules to the accumulations of snow or ice or combinations thereof.

### CROSS-REFERENCE TO RELATED APPLICATIONS

This application claims priority to, and the benefit of, U.S. Provisional Patent Application No. 62/396,500 by William Reid et al. entitled “TRUCK ICE AND SNOW MELTING SYSTEM”, filed on Sep. 19, 2016, the entire contents of which are incorporated herein by reference.

### BACKGROUND

Commercial trailer truck vehicles of various types are on the open road or are parked during periods of heavy snow and ice storms. While on the road or when parked, the roofs of such vehicles become loaded with ice and snow which decrease the fuel economy of the vehicles and also are a safety hazard on the open road during transit as ice and snow falling off the roofs of such vehicles can cause serious injuries and accidents to vehicles following in their paths. In fact, many states and localities have enacted legislation prohibiting travel unless the roofs are cleared of ice and snow.

### SUMMARY

The present disclosure relates to significant and unobvious n ice and snow melting systems that include, for a surface of a transitory vehicle subject to receiving accumulations of snow or ice or combinations thereof when the transitory vehicle is stationary or in motion, one or more heating modules configured to be disposed on or beneath the surface to transfer heat to the accumulations of snow or ice or combinations thereof when the transitory vehicle is stationary or in motion; and a power source in communication with the one or more heating modules to effect transfer of heat from the heating modules to the accumulations of snow or ice or combinations thereof.

### BRIEF DESCRIPTION OF THE DRAWINGS

FIG. 1 is a general drawing illustrating various trailers to which the system for melting ice and snow either prior to travel, during transit, or following transit of commercial trailer truck vehicles may be applied;

FIG. 2 is an elevation view of a common tractor-trailer that includes a system 100 for melting ice and snow according to embodiments of the present disclosure;

FIG. 3 is a plan view of the common tractor-trailer of FIG. 2 that includes the system for melting ice and snow according to embodiments of the present disclosure;

FIG. 4 is a trailer of a refrigeration tractor-trailer in a stationary position without a tractor and which includes the system for melting ice and snow according to embodiments of the present disclosure;

FIG. 5 illustrates a logic diagram of a control system that controls electrical power to the electrical heating unit modules for the system for melting ice and snow according to embodiments of the present disclosure;

FIG. 6A illustrates amorphous metal ribbons that may be incorporated into jacketed amorphous conductive ribbon cable strips;

FIG. 6B illustrates jacketed amorphous conductive ribbon cable strip that include the amorphous metal ribbons of FIG. 6A that may be incorporated into the systems for melting snow and ice according to embodiments of the present disclosure;

FIG. 6C is a cross-section of the jacketed amorphous conductive ribbon cable strip taken along section line 6C-6C of FIG. 6B;

FIG. 6D illustrates an example of a conductive mat assembly wherein the jacketed amorphous conductive ribbon cable strips are incorporated in a continuous loop configuration within a transparent plastic mat;

FIG. 6E is a view of another type of conductive film or ribbon that may be incorporated into the systems for melting snow and ice according to embodiments of the present disclosure;

FIG. 6F is a perspective view of the conductive film or ribbon of FIG. 6E;

FIG. 6G is a view of the conductive film or ribbon of FIGS. 6E and 6F configured in a roll;

FIG. 6H is a view of a roll of reflective metallic film that may be incorporated into the systems for melting snow and ice according to embodiments of the present disclosure;

FIG. 7 illustrates a refrigerated trailer without a tractor that is generally similar to the refrigerated trailer described above with respect to FIG. 4 wherein the refrigerated trailer now includes an ice and snow melting system that is functionally equivalent to the ice and snow melting systems of FIGS. 2 and 3 according to embodiments of the present disclosure;

FIG. 8 illustrates another refrigerated trailer without a tractor that is also generally similar to the refrigerated trailer described above with respect to FIG. 4 wherein the refrigerated trailer now includes yet another an ice and snow melting system that is also functionally equivalent to the ice and snow melting systems of FIGS. 2 and 3 according to embodiments of the present disclosure;

FIG. 9 illustrates still another refrigerated trailer without a tractor that is also generally similar to the refrigerated trailer described above with respect to FIG. 4 wherein the refrigerated trailer now includes still another ice and snow melting system that is also functionally equivalent to the ice and snow melting systems of FIGS. 2 and 3 according to embodiments of the present disclosure;

FIG. 10 illustrates yet another refrigerated trailer without a tractor that is also generally similar to the refrigerated trailer described above with respect to FIG. 4 wherein the refrigerated trailer now includes still another ice and snow melting system that is also functionally equivalent to the ice and snow melting systems of FIGS. 2 and 3 according to embodiments of the present disclosure; and

FIG. 11 illustrates yet another refrigerated trailer without a tractor that is also generally similar to the refrigerated trailer described above with respect to FIG. 4 wherein the refrigerated trailer now includes still further ice and snow melting system that is also functionally equivalent to the ice and snow melting systems of FIGS. 2 and 3 according to embodiments of the present disclosure and wherein the ice and snow melting system that is particularly suited for installation in a trailer during the manufacturing phase of the trailer.

FIG. 12 illustrates side by side tables of example materials which can be utilized for application of the ice and snow melting systems according to embodiments of the present disclosure to a shipping trailer and to a cargo trailer for maritime transport;

FIG. 13 is a side elevation view of a shipping trailer for which the example materials of the Table of FIG. 12 may be applied to the ice and snow melting systems according to embodiments of the present disclosure;

FIG. 14 is a rear elevation view of the shipping trailer of FIG. 13 for which the example materials of the Table of FIG. 12 may be applied to the ice and snow melting systems according to embodiments of the present disclosure;

FIG. 15 is a perspective view of the materials of FIG. 12 as applied to an upper surface of the shipping trailer of FIGS. 13 and 14;

FIG. 16 is a side elevation view of a cargo trailer for maritime transport for which the example materials of the Table of FIG. 12 may be applied to the ice and snow melting systems according to embodiments of the present disclosure;

FIG. 17 is a rear elevation view of the shipping trailer of FIG. 16 for which the example materials of the Table of FIG. 12 may be applied to the ice and snow melting systems according to embodiments of the present disclosure; and

FIG. 18 is a perspective view of the materials of FIG. 12 as applied to an upper surface of the cargo trailer of FIGS. 16 and 17.

### DETAILED DESCRIPTION

The embodiments of the present disclosure provide significant and unobvious advantages in addressing the foregoing undesirable consequences by relating to a system for melting ice and snow either prior to travel, during transit, or following transit of commercial trailer truck vehicles.

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” may be used herein to mean “serving as an example, instance, or illustration.” Any embodiment described herein as “exemplary” is not necessarily to be construed as preferred or advantageous over other embodiments.

It is to be understood that the method steps described herein need not necessarily be performed in the order as described. Further, words such as “thereafter,” “then,” “next,” etc., are not intended to limit the order of the steps. Such words are simply used to guide the reader through the description of the method steps.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, tablets, portable/personal digital assistants, and other devices that facilitate communication of information between end-users within a network.

The general features and aspects of the present disclosure remain generally consistent regardless of the particular purpose. Further, the features and aspects of the present disclosure may be implemented in system in any suitable fashion, e.g., via the hardware and software configuration of system or using any other suitable software, firmware, and/or hardware. For instance, when implemented via executable instructions, such as the set of instructions, various elements of the present disclosure are in essence the code defining the operations of such various elements. The executable instructions or code may be obtained from a computer-readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media may include any medium that may store or transfer information.

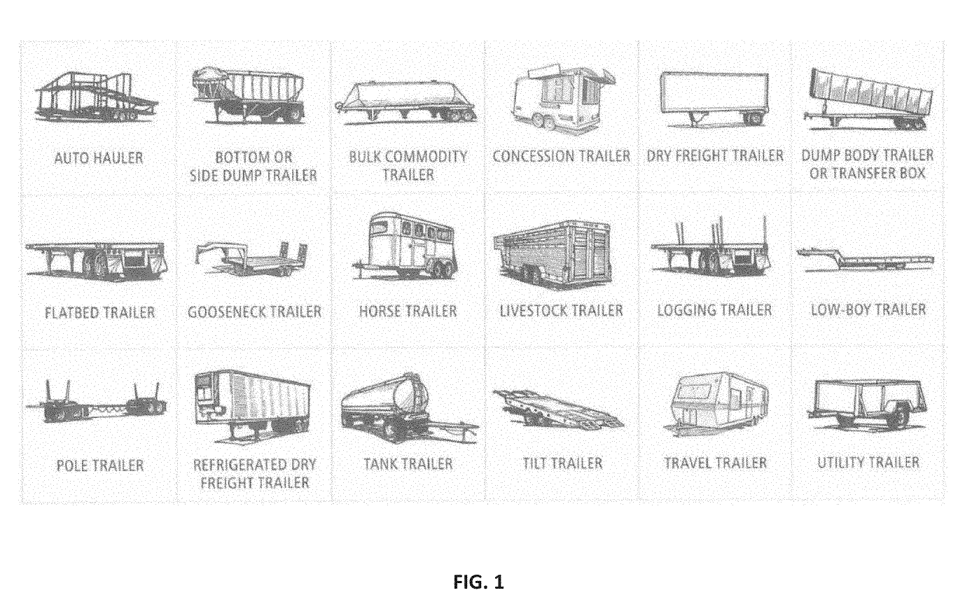

FIG. 1 is a general drawing illustrating various trailers to which the system for melting ice and snow either prior to travel, during transit, or following transit of commercial trailer truck vehicles may be applied.

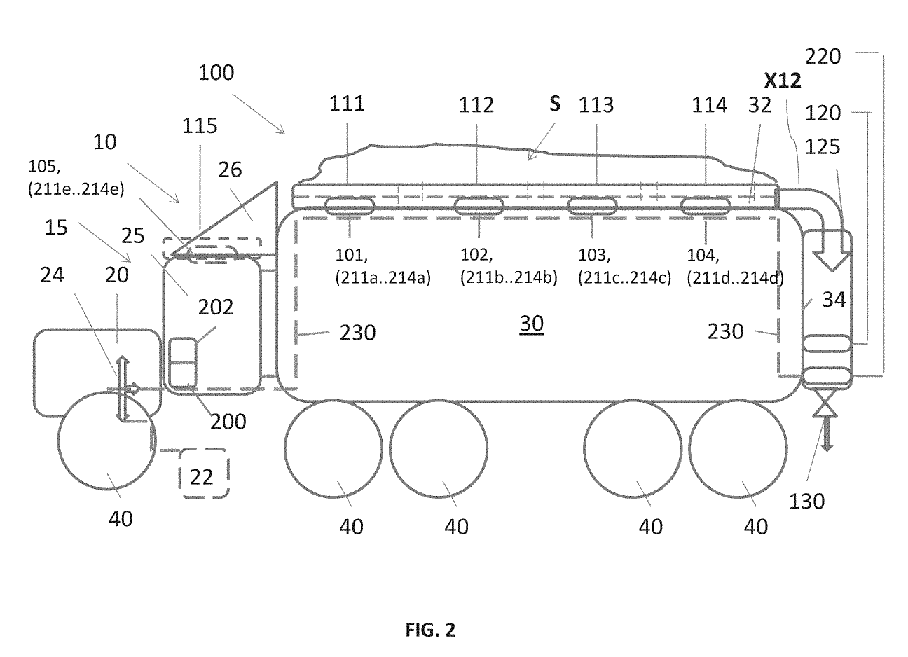

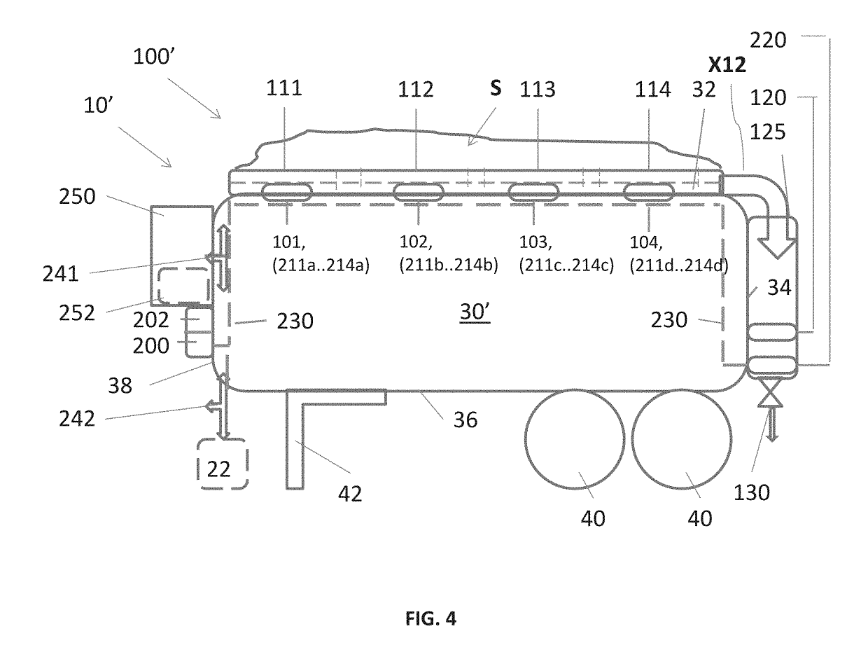

FIG. 2 is an elevation view of a common tractor-trailer 10 that includes a system 100 for melting ice and snow according to embodiments of the present disclosure. The tractor-trailer 10 includes a tractor 15 having an engine 20 that includes an electrical generator, and a cab 25 for the operator wherein the tractor 15 is connected to trailer 30. A streamlining wind shield 26 may be positioned over the cab 25. The engine 20 and the trailer 30 are directly supported by wheels 40. The trailer 30 includes a roof 32 and a rear portion 34. The tractor-trailer 10 may also include a refrigeration module (not shown) that is discussed in detail below with respect to FIG. 4. The truck ice and snow melting system 100 includes a 3-way switch 24 that may either be in an off position or connected to the electrical generator of the engine 20 or optionally to an off-vehicle power supply 22. The off-vehicle power supply 22 may include where available electrical grid power at a truck rest stop location or from a building such as a load destination. Where feasible, the off-vehicle power supply 22 may be a free-standing power source such as a battery bank or fuel cell bank or supercapacitor bank or the like. Where feasible, the free-standing power sources may also be applied as on-vehicle power supplies that are separate from the electrical generator of the truck engine 20 and are mounted at a suitable location on the tractor 15 or on the trailer 30. Via power and control cable routing 230, the switch 24 is in electrical communication with a processor 200 having a display 202 and which is generally located inside the cab 25, although other suitable locations may be selected by those skilled in the art, e.g., the processor might be located on top of the roof 32 near the cab 25 but in a weather-proof sealed enclosure.

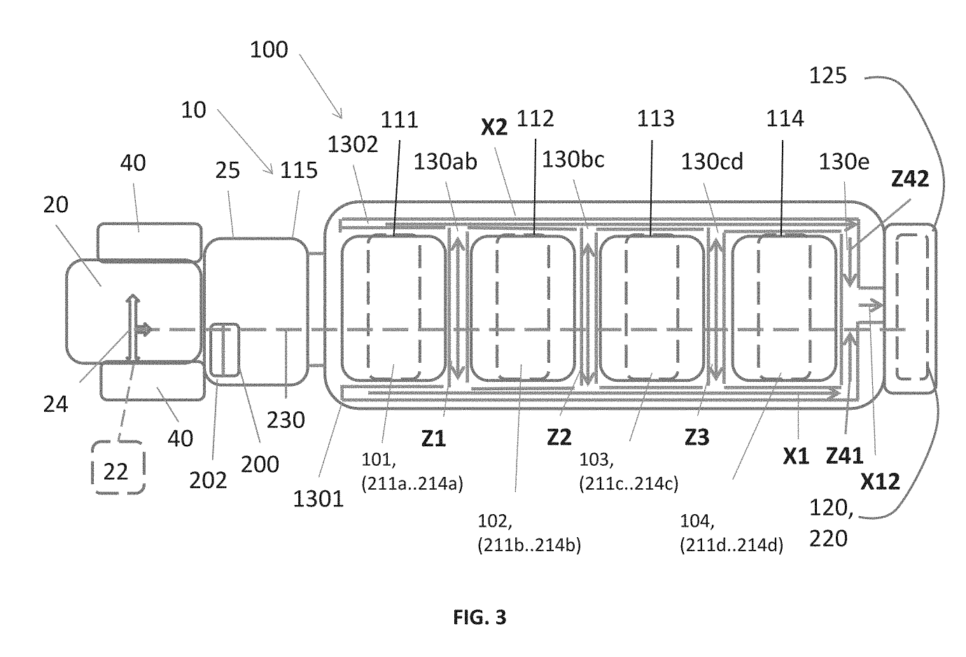

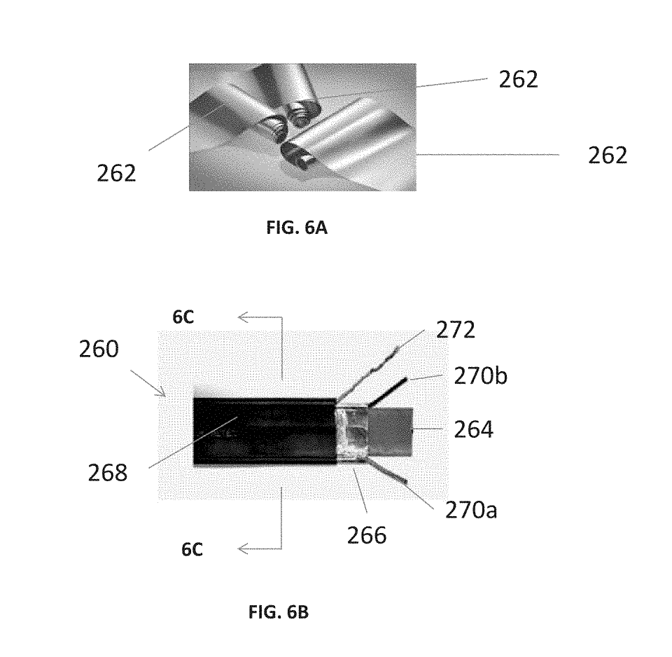

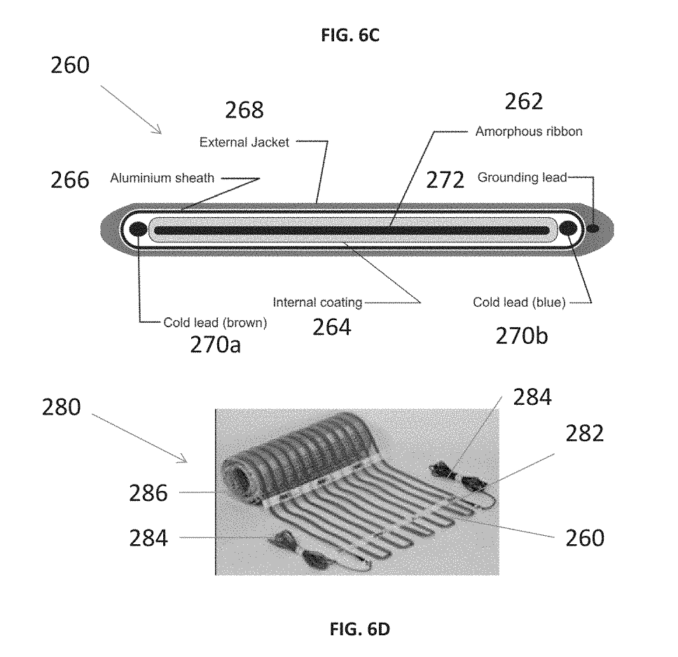

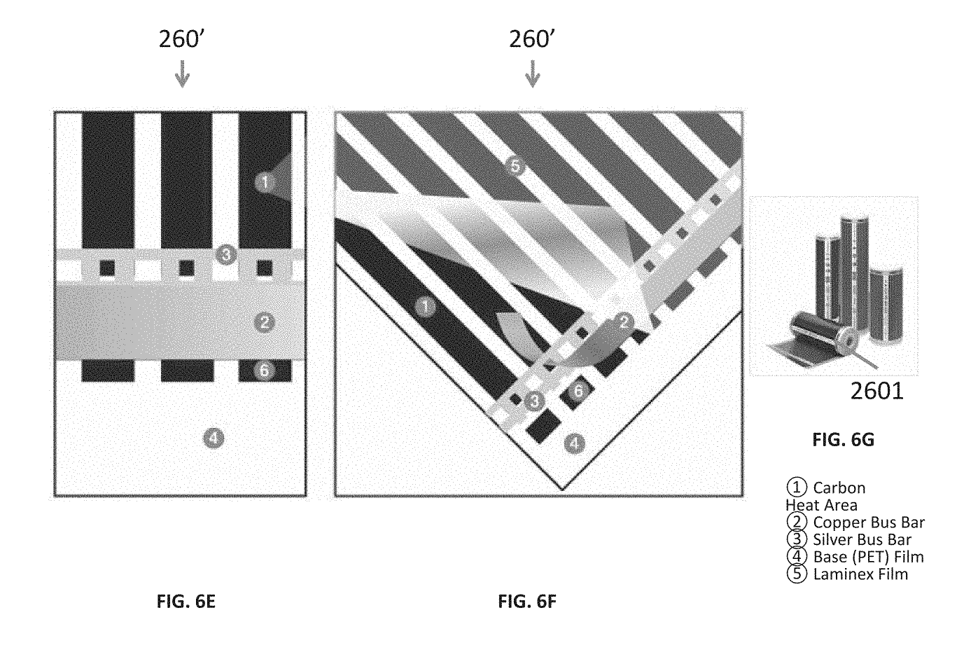

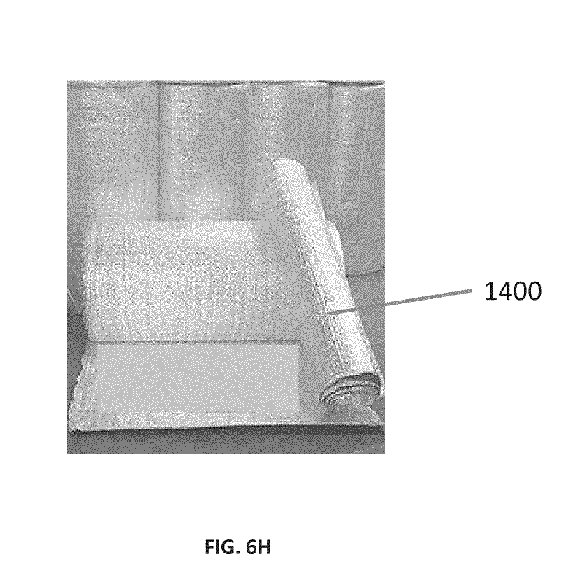

Also via power and control cable routing 230, the processor 200 is in electrical communication with, as shown generically in FIGS. 2 and 3, at least one modular electrical heating unit and generally at least two modular electrical heating units 101, 102, 103 and 104, e.g., electrical resistance heating units, that are separately positioned as shown in FIG. 2 on the external surface of roof 32 at intervals along the roof 32. An optional fifth electrical heating unit module 105 as shown in dashed lines may be positioned over the cab 25. As explained in more detail below with respect to FIGS. 6A-6D and 7-11, the modular electrical heating units 101, 102, 103, 104 and 105 may be in the form of material mats or ribbons that generate heat by flow of electric current therethrough.

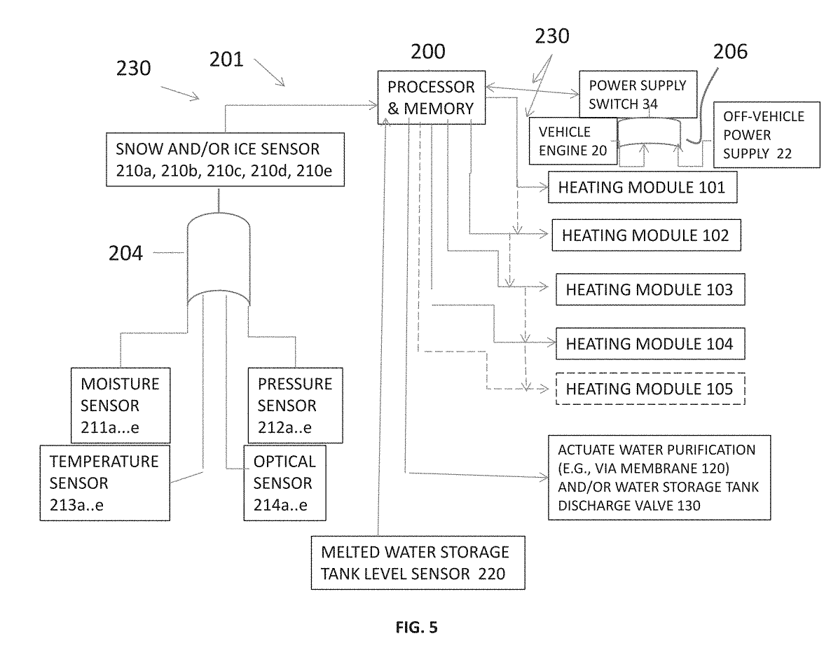

Referring also to FIG. 5 which will be discussed in detail below, either disposed internally within the electrical heating unit modules 101 to 105 are snow and ice sensors 210a, 210b, 210c, 210d and 210e that are each in electrical communication with the processor 200 via the power and control cable routing 230 to respectively actuate or terminate operation of the electrical heating unit modules 101 to 105.

The electrical heating unit modules 101 to 105 are positioned in various ways in thermal communication with, respectively, sealing structure or structures 111, 112, 113, 114 that are illustrated as being on the external surface of the roof 32, and optionally respectively with sealing structure 115 that is positioned over the cab 25. The sealing structure or structures 111, 112, 113 and 114 thus transfer heat generated by the electrical heating units 101 to 104 to the snow or ice S which is then melted any may flow over the roof 32 and towards the rear portion 34 of the trailer 30 in the direction X12. An optional melted water storage tank 125 may be mounted on the rear portion 34 and may include a water purification means 120, e.g., a membrane filter, and a melted water storage tank level sensor 220 that is also in electrical communication with the processor 200 via the power and control cable routing 230 to open or close melted water storage tank discharge valve 130 that is shown directing water flow towards the bottom of the trailer 30 (e.g., the road surface). In embodiments, the melted water flow directed in the direction X12 may be contained via a structural means such as a pipe or tube, etc. and discharged either directly to the road surface or into the melted water storage tank 125.

The electrical heating unit modules 101 to 104 alternatively may be positioned on the interior surface of the roof 32 as long as there is thermal communication with the sealing structure or structures 111 to 114, respectively.

Again as explained in detail below with respect to FIGS. 6A-6D and 7-11, the sealing structure or structures 111 to 114 may be applied to either the exterior surface or interior surface of the roof 32 via a spray-on sealant or adhesive, by vinyl wrap, heavy gauge wire, by magnets or other means known in the art including, but not limited to, male and female connectors.

FIG. 3 is a plan view of the tractor-trailer 10 with the snow and ice melting system 100 of FIG. 2. In the configuration wherein it is desired to collect the melted snow and ice water, the sealing structure or structures 111, 112, 113 and 114 are spaced apart along the roof 32 so as to form parallel lateral channels 130ab, 130bc and 130cd between 111 and 112, 112 and 113 and 113 and 114. As shown by the double arrows Z1, Z2, Z3, melted snow and ice water is directed from the lateral channels 130ab, 130bc and 130cd to parallel longitudinal channels 1301 and 1302 that form a ladder-type configuration. The melted snow and ice water then flows in the longitudinal channels 1301 and 1302 towards the rear portion 34 of the trailer 30 as shown by the single arrows X1 and X2 respectively to a lateral channel 130e on the trailing edge of the sealing structure 114. The lateral channel 130e is parallel to the other lateral channels 130ab, 130bc and 130cd and directs the melted snow and ice water in the direction of single arrows Z41 and Z42 to a common channel in the direction X12 to discharge the melted snow and ice water in the direction X12 at the rear portion 34 of the trailer 30 where it may directly be discharged to the road surface or stored in the melted water storage tank 125.

In the example embodiment of FIGS. 2 and 3, membrane 120 is located within the tank 125 and above the level indicator 220 to allow the filtered water to pass through the discharge valve 130.

FIG. 4 is a trailer 30′ of a refrigeration tractor-trailer 10′ in a stationary position without a tractor. Trailer 30′ is now a refrigerated trailer having an engine-driven packaged refrigeration unit 250 that is shown mounted externally to front wall 38 of the trailer 30′. When in the stationary configuration as shown, the trailer 30′ is supported by a support frame or stanchion 42 underneath floor 36 as known in the art that is lowered into position when the front wheels 40 that are part of the tractor are no longer present, such as, for example, due to the common need for the refrigerated trailer 30′ to be placed in the stationary configuration while its contents are gradually removed to supply a customer such as a supermarket, etc. During these situations, snow S can easily accumulate on the roof 32. When in this configuration, those skilled in the art will recognize and understand that system 100′ for melting ice and snow accumulating on refrigerated trailer 30′ is generally identical to system 100 for tractor-trailer 10 as described above with respect to FIGS. 2 and 3 except that the tractor engine 20 is no longer available as a power source. Rather, power is now provided by engine 252 within the engine-driven packaged refrigeration unit 250 that may be connected to the power and control cable routing 230 via a switch 241. (The engine 252 drives an electrical generator and a compressor each located within the enclosure of the engine-driven packaged refrigeration unit 250 and which are not shown). When switch 241 is in the open position, power may alternatively be provided by closing switch 242 to provide power to the power and control cable routing 230 via the off-vehicle. The processor and memory 200 and display 202 for the system 100′ for melting ice and snow are shown also located outside the trailer 30′ on the front wall 38 but could also be located within the enclosure of the engine-driven packaged refrigeration unit 250. Those skilled in the art will recognize that the system 100′ for melting ice and snow accumulating on refrigerated trailer 30′ may generally be operated in a similar manner as described above with respect to FIGS. 2 and 3 and as described below with respect to FIG. 5.

When the refrigerated trailer 30′ is connected to a tractor, when in a mobile mode, the system 100′ for melting ice and snow is then capable of being configured to be provided power from engine 20. When in a stationary mode, the system 100′ for melting ice and snow is then capable of being configured to be provided power from tractor engine 20, from the engine 252 within the engine-driven packaged refrigeration unit 250 or from the off-vehicle power source 22.

FIG. 5 illustrates control system 201 that controls electrical power to the electrical heating unit modules 101, 102, 103, 104 and 105. Upon receiving a signal from any one or more of snow and/or ice sensors 210a, 210b, 210c, 210d or 210e, the processor 200 actuates the associated heating modules 101, 102, 103, 104 or 105 via the power and control cable routing 230. If the tractor-trailer is in transit, through the logic OR gate 206, the processor 200 directs the 3-way switch 24 to supply power from the engine 20. If the off-vehicle power supply 22 is electrically connected to the power and control cable routing 230, the processor 200 preferentially directs the 3-way switch 24 to supply power from the off-vehicle power supply 22 (that may alternatively be an on-vehicle power supply as described above).

The snow and/or ice sensor 210a may be selected via logic OR gate 204 as one or more of moisture sensor 211a, pressure sensor 212a, temperature sensor 213a, or optical sensor 214a. Similarly, sensor 210b relates through logic OR gate 204 to one or more of moisture sensor 211b, pressure sensor 212b, temperature sensor 213b, or optical sensor 214b. The same applies to sensors 210c, 210d and 210e as they relate to 211c, 212c, 213c and 214c, sensors 211d, 212d, 213d and 214d, and sensors 211e, 212e, 213e and 214e, respectively.

The processor 200 may actuate all of the electrical heating modules 101 to 105 simultaneously, or in a particular sequence depending on the location of the snow S on the roof 32, which can be progressive or random. The operating cycle time for the electrical heating modules 101 to 105 may be pre-set from the memory in the processor or may be terminated upon pre-set levels transmitted by the snow and/or ice sensors 210a to 210e.

The control system 201 may be manually actuated by the vehicle operator from the cab 25 and system operation is provided on the display 202.

If the trailer 32 includes the melted water storage tank 125, upon receiving an actuation signal from the melted water storage tank level sensor 220, the processor 200 either actuates the water purification mode to cause the melted water in the tank to be filtered by the water purification means 120 which may be a membrane or discharges the water in an unfiltered condition through the discharge valve 130. Thus, the water may be discharged either in filtered or unfiltered condition through the discharge valve 130 that is actuated by the processor 200.

Those skilled in the art will recognize that and understand how the control system 201 is applied to operate either in a mobile or stationary mode the system 100′ for melting ice and snow accumulating on refrigerated trailer 30′.

FIGS. 6A-6D illustrate a specific example of the modular electric heating units 101, 102, 103 and 104 (and also 105) that may be employed as part of the ice and snow melting systems 100 or 100′. FIG. 6A illustrates amorphous metal ribbon 262 that may be incorporated into jacketed amorphous conductive ribbon cable strips 260 as illustrated in FIGS. 6B and 6C. FIG. 6C is a cross-section of a jacketed amorphous conductive ribbon cable strip 260 taken along section line 6C-6C of FIG. 6B. The jacketed amorphous conductive ribbon cable strip 260 includes in the center thereof an amorphous metal strip 262 (shown in FIG. 6C) that is enclosed within an internal coating 264 generally made from polyester. In turn, the amorphous metal strip 262 and the internal coating 264 are enclosed within an aluminum sheath 266. The aluminum sheath 266 also encloses a first cold lead 270a and a second cold lead 270b that are disposed in a parallel configuration running along either edge of the internal coating 264. The aluminum sheath 266 and first cold lead 270a and second cold lead 270b are in turn enclosed within an external jacket 268. The external jacket 268 also encloses a grounding lead 272 running along one edge of the external jacket 268 and in proximity to the second cold lead 270b. The jacketed amorphous conductive ribbon cable strips 260 are available from Applied Heating Technologies, Ltd. (AHL Netherlands B.V. and Latsia, Cyprus).

FIG. 6D illustrates an example of a conductive mat assembly 280 wherein the jacketed amorphous conductive ribbon cable strips 260 are incorporated in a continuous loop configuration within a transparent plastic mat 282. The jacketed amorphous conductive ribbon cable strips 260 are terminated by power supply cords 284 on either end. The conductive mat assembly 280 is then rolled around a roller tube 286 for dispensing. The conductive mat assembly 280 (and roller tube 286) is also available from Applied Heating Technologies, Ltd. (AHL Netherlands B.V. and Latsia, Cyprus). The conductive mat assembly 280 therefore is capable of converting electrical power input to heat for melting ice and snow via the jacketed amorphous conductive ribbon cable strips 260.

FIG. 6E is a view of another example of a type of conductive film or ribbon that may be incorporated into the systems for melting snow and ice according to embodiments of the present disclosure.

FIG. 6F is an alternate view of the conductive film or ribbon of FIG. 6E.

More particularly, referring to both FIGS. 6E and 6F, conductive film or ribbon 260′ includes a carbon heat area 1 in the form of parallel, longitudinal strips that are in electrical communication with one another via a copper bus bar 2 that is mounted across the longitudinal carbon strips and also via a silver bus bar 3 that is mounted across the longitudinal carbon strips and which is in turn also in electrical communication with the copper bus bar 2.

The carbon heat area 1, the copper bus bar 2 and the silver bus bar 3 are mounted over a polyethylene (PET) base film 4.

A laminex film 5 is mounted over the assembly of the carbon heat area 1, the copper bus bar 2 the silver bus bar 3 and the PET base film 4.

FIG. 6G illustrates the conductive film or ribbon 260′ configured in the form of a roll 2601.

The conductive film or ribbon 260′ is commercially available from SH Korea Co. LTD., Busan Korea.

FIG. 6H illustrates an example of an insulating roll 1400 that includes aluminum foil layers between which are layers of polyethylene backing polyethylene core with a closed-cell polyethylene foam encased in the center between the layers of aluminum foil and polyethylene backing. Insulating roll 1400 is commercially available as Prodex Total 48 Inch Insulation having an R-value 16 insulation manufactured by Insulation4Less of Houston, Tex., USA.

The conductive film or ribbon 260′ and insulating roll 1400 are another specific example of the modular electric heating units 101, 102, 103 and 104 (and also 105) that may be employed as part of the ice and snow melting systems 100 or 100′.

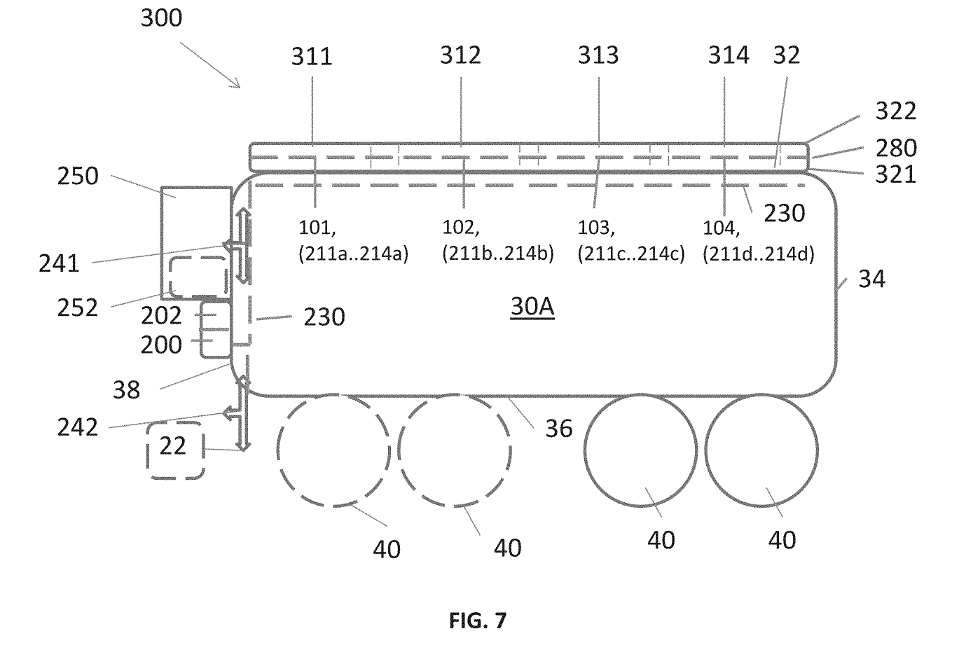

FIGS. 7-11 illustrate specific configurations and constructions of the snow and ice melting systems 100 and 100′ that are functionally equivalent to the generic configuration of the modular electrical heating elements 101, 102, 103 and 104 that have been described above with respect to FIGS. 2-4.

More particularly, FIG. 7 illustrates a refrigerated trailer 30A without a tractor that is generally similar to the refrigerated trailer 30′ described above with respect to FIG. 4. The refrigerated trailer 30A now includes an ice and snow melting system 300 that is functionally equivalent to the ice and snow melting systems 100 and 100′ described above according to embodiments of the present disclosure. The trailer 30A includes metallic roof 32 generally made from metals such as steel, tin or aluminum or combinations thereof. Conductive mat assembly 280 is installed generally above the roof 32 and sandwiched between a lower layer 321 of vinyl wrap having adhesive on both surfaces to enable adherence to the roof 32 and also to the conductive mat assembly 280. An upper layer 322 of vinyl wrap includes adhesive on one side to enable adherence to the opposite surface of the conductive mat assembly 280. The conductive mat assembly 280 may be installed across the entire length of the roof 32 or in separated segments 311, 312, 313, 314, etc. traversing the width of the roof 32. The ice and snow melting system 300 may be applied as a retrofit to existing tractor-trailers or incorporated within newly constructed tractor-trailers.

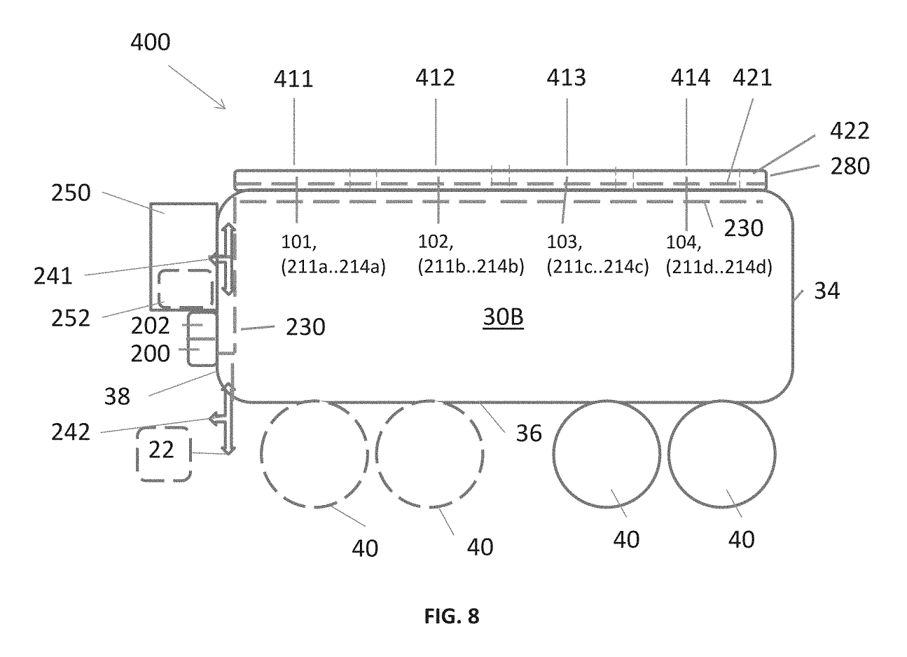

FIG. 8 illustrates another refrigerated trailer 30B without a tractor that is also generally similar to the refrigerated trailer 30′ described above with respect to FIG. 4. The refrigerated trailer 30B now includes an ice and snow melting system 400 that is also functionally equivalent to the ice and snow melting systems 100 and 100′ described above according to embodiments of the present disclosure. The trailer 30B includes a fiberglass roof 421. Conductive mat assembly 280 is installed generally above the fiberglass roof 421 wherein the lower surface of the conductive mat assembly 280 is adhered to the roof 421 via an adhesive while the upper surface of the conductive mat assembly 280 is disposed beneath an upper layer of fiberglass 422. The upper layer of fiberglass 422 includes adhesive on one side to enable adherence to the opposite surface of the conductive mat assembly 280. The conductive mat assembly 280 may be installed across the entire length of the roof 421 or in separated segments 411, 412, 413, 414, etc. traversing the width of the roof 421. In a similar manner, the ice and snow melting system 400 may be applied as a retrofit to existing tractor-trailers or incorporated within newly constructed tractor-trailers.

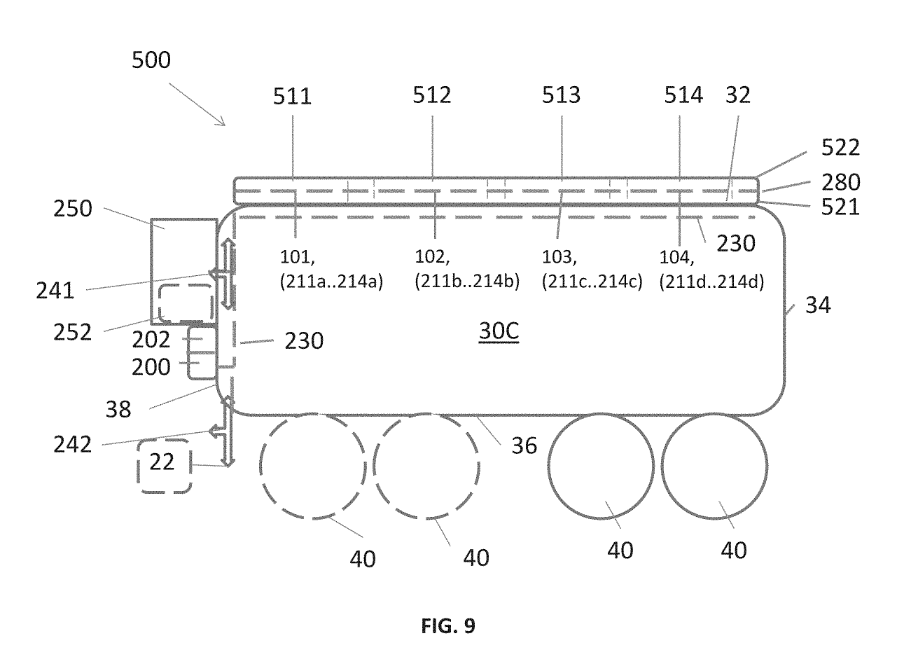

FIG. 9 illustrates still another refrigerated trailer 30C without a tractor that is also generally similar to the refrigerated trailer 30′ described above with respect to FIG. 4. The refrigerated trailer 30C now includes an ice and snow melting system 500 that is also functionally equivalent to the ice and snow melting systems 100 and 100′ described above according to embodiments of the present disclosure. The trailer 30C includes metallic roof 32 generally made from metals such as steel, tin or aluminum or combinations thereof. Conductive mat assembly 280 is installed generally above the metallic roof 32 wherein the lower surface of the conductive mat assembly 280 is adhered to the metallic roof 32 via a spray-on adhesive sealant layer 521 while the upper surface of the conductive mat assembly 280 is sealed via a spray-on adhesive sealant layer 522. The conductive mat assembly 280 may be installed across the entire length of the roof 32 or in separated segments 511, 512, 513, 514, etc. traversing the width of the roof 32. Again in a similar manner, the ice and snow melting system 500 may be applied as a retrofit to existing tractor-trailers or incorporated within newly constructed tractor-trailers.

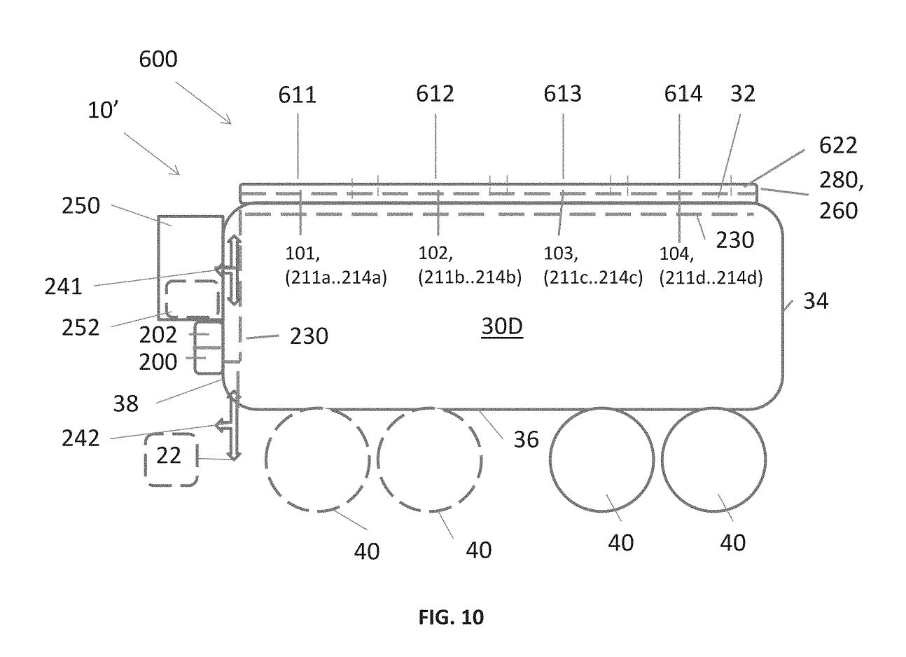

FIG. 10 illustrates yet another refrigerated trailer 30D without a tractor that is also generally similar to the refrigerated trailer 30′ described above with respect to FIG. 4. The refrigerated trailer 30D now includes an ice and snow melting system 600 that is also functionally equivalent to the ice and snow melting systems 100 and 100′ described above according to embodiments of the present disclosure. The trailer 30D includes a lower metallic roof 32 generally made from metals such as steel, tin or aluminum or combinations thereof. Conductive mat assembly 280 or individual jacketed amorphous conductive ribbon cable strips 260 installed are generally above the metallic roof 32 and between an upper metallic roof 622 that is also generally made from steel, tin or aluminum or combinations thereof wherein the conductive mat assembly 280 is secured to the metallic roof 32 and to the upper metallic roof 622 via connecting means such as rivets, bolts and nuts, magnets, etc. as known in the art. The conductive mat assembly 280 may be installed across the entire length of the roof 32 or in separated segments 611, 612, 613, 614, etc. traversing the width of the roof 32. Again in a similar manner, the ice and snow melting system 600 may be applied as a retrofit to existing tractor-trailers or incorporated within newly constructed tractor-trailers.

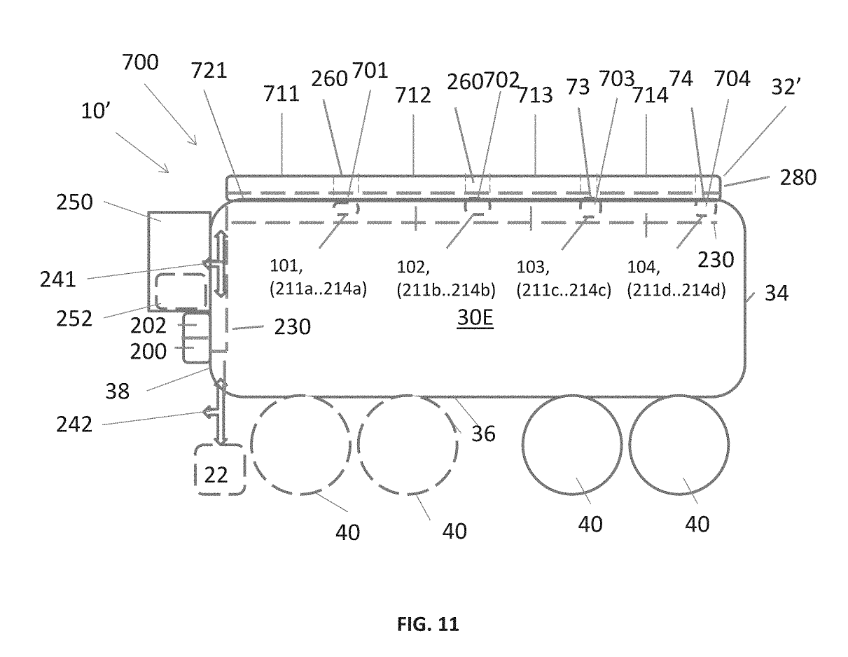

FIG. 11 illustrates yet a further refrigerated trailer 30E without a tractor that is also generally similar to the refrigerated trailer 30′ described above with respect to FIG. 4. The refrigerated trailer 30E now includes an ice and snow melting system 700 that is also functionally equivalent to the ice and snow melting systems 100 and 100′ described above according to embodiments of the present disclosure. The ice and snow melting system 700 is particularly suited for installation in a trailer during the manufacturing phase of the trailer. Accordingly, trailer 30E includes a metallic roof 32′ that prior to completion includes a lower panel 721 generally made from metals such as steel, tin or aluminum or combinations thereof and also includes channels 701, 702, 703, 704, etc. to create separated segments 711, 712, 713, 714, etc. traversing the width of the roof 32. When panel 721 and the channels 701, 702, 703, 704, etc. are exposed, individual jacketed amorphous conductive ribbon cable strips 260 may be installed in the channels 701, 702, 703, 704, etc. to traverse the width of the trailer 30E. Additionally, conductive mat assembly 280 may be installed above the lower panel 721 and between an upper metallic panel 722 that is also generally made from steel, tin or aluminum that when installed forms the roof 32′. The conductive mat assembly 280 may be secured to the lower panel 721 and/or to the upper panel 722 via connecting means such as rivets, bolts and nuts, magnets, etc. as known in the art. Again in a similar manner, although the ice and snow melting system 700 has been described as being incorporated within newly constructed tractor-trailers, those skilled in the art will recognize that and understand how the ice and snow melting system 700 may be applied also as a retrofit to existing tractor-trailers.

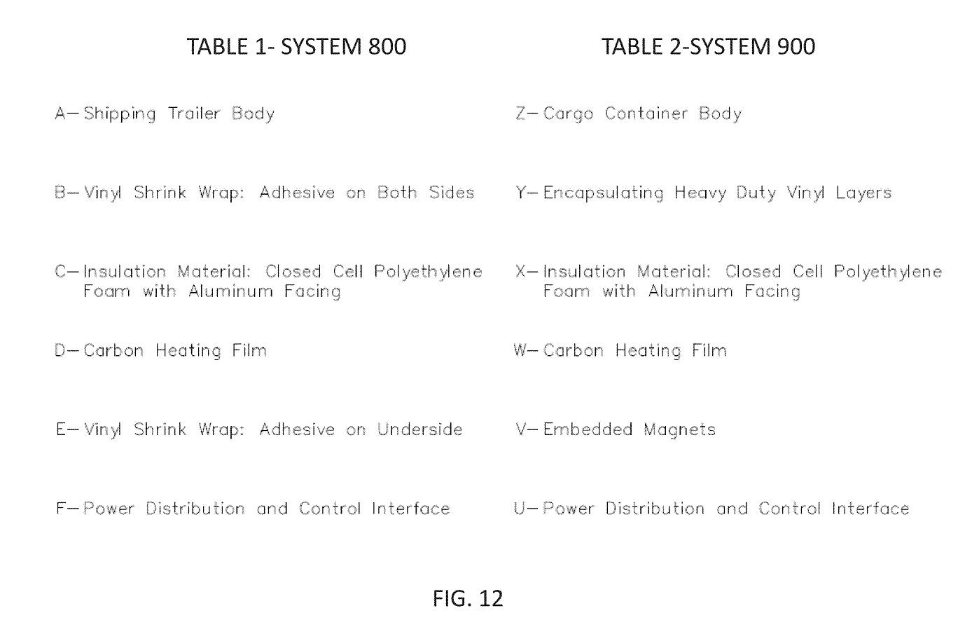

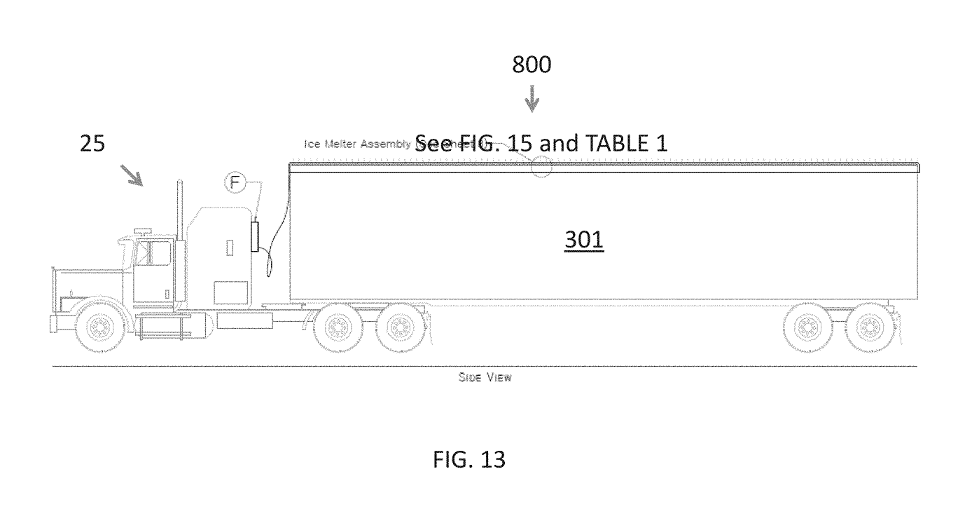

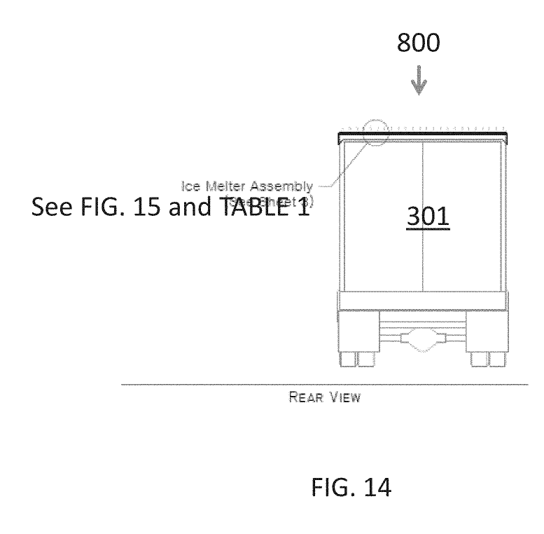

FIG. 12 illustrates TABLE 1—SYSTEM 800 and TABLE 2—SYSTEM 900 of example materials which can be utilized for application of the ice and snow melting systems according to embodiments of the present disclosure to a shipping trailer and to a cargo trailer for maritime transport. More particularly, in TABLE 1—SYSTEM 800, Item A refers to a shipping trailer body (301 in FIGS. 13 and 14), Item B refers to Vinyl shrink wrap with adhesive on both sides, and Item C refers to insulation material, e.g., closed cell polyethylene foam with aluminum facing such as described above with respect to FIG. 6H. Item D refers to the carbon heating film, e.g., carbon conductive film or ribbon 260′ as described above with respect to FIGS. 6E, 6F and 6G. Item E refers to the vinyl shrink wrap and is the same as Item B. Item F refers to the power distribution and control interface 201 of FIG. 5.

FIG. 13 is a side elevation view of a shipping trailer 301 for which the example materials of TABLE 1—SYSTEM 800 of FIG. 12 may be applied as the ice and snow melting system 800 according to embodiments of the present disclosure. The components and configuration of the shipping trailer 301 are generally the same as trailer 30 shown and described in FIGS. 2-4 and are not separately numbered. Item F refers to the power distribution and control interface 201 of FIG. 5.

FIG. 14 is a rear elevation view of the shipping trailer 301 of FIG. 13 for which the example materials of TABLE 1—SYSTEM 800 of FIG. 12 may be applied as the ice and snow melting system 800 according to embodiments of the present disclosure.

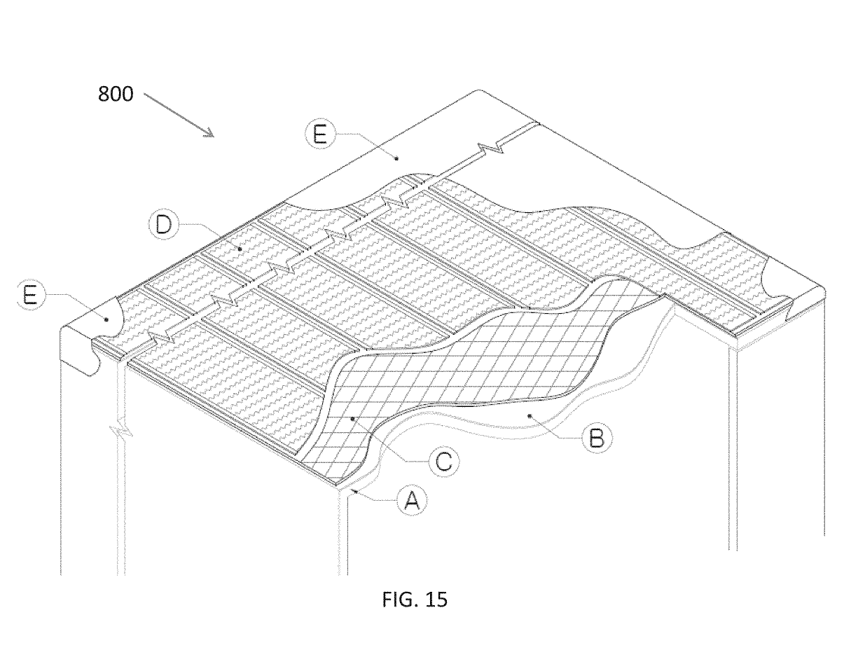

FIG. 15 is a perspective view of the materials of TABLE 1—SYSTEM 800 of FIG. 12 as applied to an upper surface of the shipping trailer 301 of FIGS. 13 and 14. Item B refers to Vinyl shrink wrap with adhesive on both sides that adheres to the upper surface of the shipping container A or 301. Item C refers to insulation material, e.g., closed cell polyethylene foam with aluminum facing such as described above with respect to FIG. 6H that is layered over the Vinyl shrink wrap B. Item D refers to the carbon heating film, e.g., carbon conductive film or ribbon 260′ as described above with respect to FIGS. 6E, 6F and 6G that is layered over the Item C conductive Vinyl shrink wrap B. Item E refers to the vinyl shrink wrap and is the same as Item B and is layered over the Item D carbon heating film, e.g., carbon conductive film or ribbon 260′.

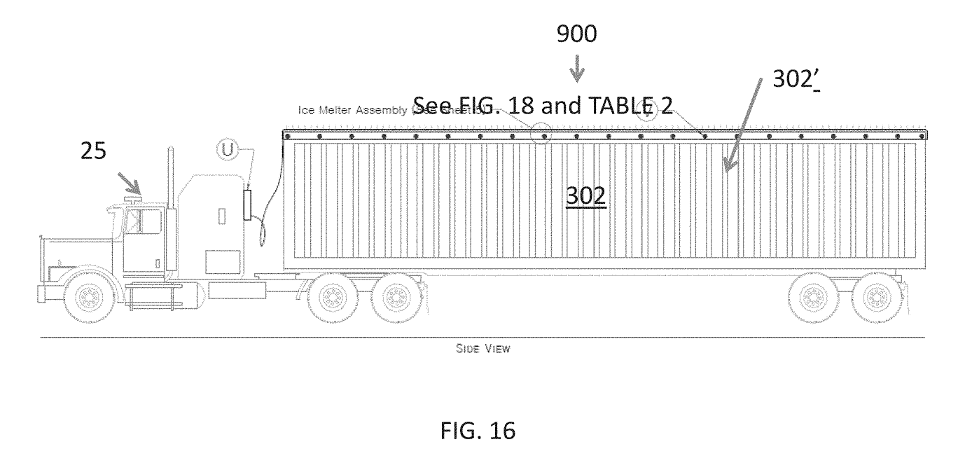

FIG. 16 is a side elevation view of a cargo trailer 302 for maritime transport for which the example materials of TABLE 2—SYSTEM 900 of FIG. 12 may be applied as the ice and snow melting system 900 according to embodiments of the present disclosure. The components and configuration of the cargo trailer 302 are generally the same as trailer 30 shown and described in FIGS. 2-4 and are not separately numbered, except that the cargo trailer 302 is fabricated from steel to endure maritime transport and thus also includes corrugated sides 302′. In a similar manner as with respect to Item F in TABLE 1, Item U refers to the power distribution and control interface 201 of FIG. 5.

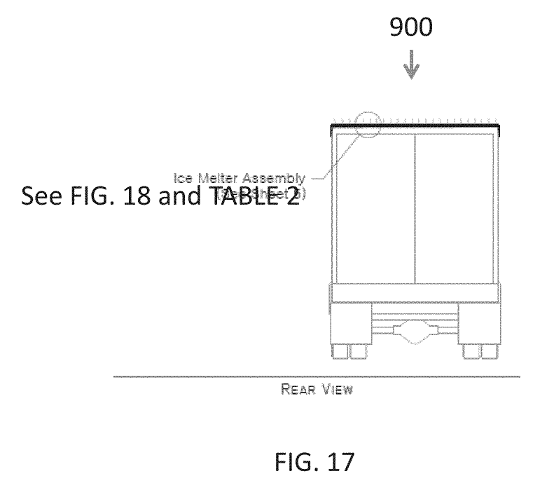

FIG. 17 is a rear elevation view of the shipping trailer of FIG. 16 for which the example materials of TABLE 2—SYSTEM 900 of FIG. 12 may be applied as the ice and snow melting system 900 according to embodiments of the present disclosure.

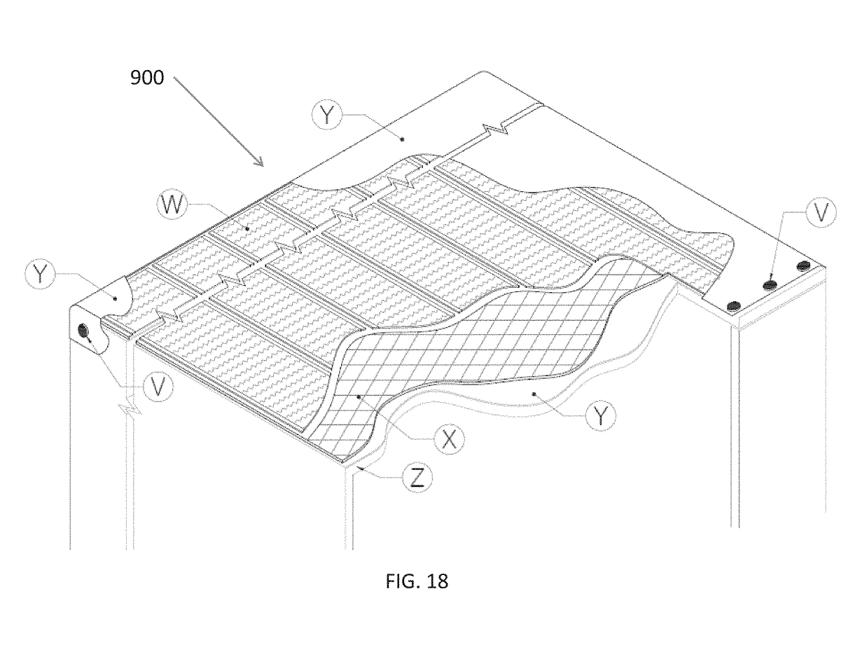

FIG. 18 is a perspective view of the materials of TABLE 2—SYSTEM 900 of FIG. 12 as applied to an upper surface of the cargo trailer 302 of FIGS. 16 and 17. More particularly, referring also to FIG. 12 and TABLE 2, the cargo container body Item Z or cargo trailer 302 includes Item Y encapsulating heavy duty vinyl layers over the upper surface of the cargo container body Item Z or cargo trailer 302. In a similar manner as Item C in TABLE 1, Item X includes insulation material, e.g., closed cell polyethylene foam with aluminum facing such as described above with respect to FIG. 6H, that is layered over the Item Y encapsulating heavy duty vinyl layers. In a similar manner as with respect to Item D in TABLE 1, Item W refers to the carbon heating film, e.g., carbon conductive film or ribbon 260′ as described above with respect to FIGS. 6E, 6F and 6G that is layered over the Item X conductive Vinyl shrink wrap and the Item Y encapsulating heavy duty Vinyl layers.

Since the cargo container body Item Z or cargo trailer 302 if made from steel, Item V includes magnets that are embedded in an upper layer Item Y of encapsulating heavy duty Vinyl layers to enable the ice and snow melting systems to be removable from the cargo container body Item Z or cargo trailer 302 prior to being mounted on a container vessel for maritime transport. Generally the ice and snow melting systems are not intended to be mounted during the maritime transport and are thus designed for usage of the trailers for ground shipping.

Those skilled in the art will recognize that and understand how the ice and snow melting systems 100, 100′, 300, 400, 500, 600, 700, 800 and 900 may be applied also to various trailers shown in FIG. 1 and to the trailer 30 shown and described in FIGS. 2-4 and further will recognize that and understand how the ice and snow melting systems 100, 100′, 300, 400, 500, 600, 700, 800 and 900 may be operated and controlled as described above with respect to control system 201 and illustrated in FIG. 5.

While several embodiments and methodologies of the present disclosure have been described and shown in the drawings, it is not intended that the present disclosure be limited thereto, as it is intended that the present disclosure be as broad in scope as the art will allow and that the specification be read likewise.

Therefore, the above description should not be construed as limiting, but merely as exemplifications of particular embodiments and methodologies. Those skilled in the art will envision other modifications within the scope of the claims appended hereto.

What is claimed is:

1. An ice and snow melting system comprising:
for a surface of a transitory vehicle subject to receiving accumulations of snow or ice or combinations thereof when the transitory vehicle is stationary or in motion,
one or more heating modules configured to be disposed on or beneath the surface to transfer heat to the accumulations of snow or ice or combinations thereof when the transitory vehicle is stationary or in motion; and
a power source in communication with the one or more heating modules to effect transfer of heat from the heating modules to the accumulations of snow or ice or combinations thereof.
